(19) United States
(12) Patent Application Publication
(10) Pub. No.: US 2012/0063563 A1
(43) Pub. Date: Mar. 15, 2012

(54) SCREW COUNTER AND ELECTRONIC DEVICE USING THE SAME

(75) Inventors: YUAN-FA HUANG, Shenzhen City (CN); WEN-JUAN NING, Shenzhen City (CN); CHANG-DONG XIANG, Shenzhen City (CN); DE-KE MA, Shenzhen City (CN); JIA CHEN, Shenzhen City (CN); YU-ZHE GENG, Shenzhen City (CN); PENG-WEI GU, Shenzhen City (CN)

(73) Assignees: HON HAI PRECISION INDUSTRY CO., LTD., Tu-Cheng (TW); HONG FU JIN PRECISION INDUSTRY (Shenzhen) CO., LTD., Shenzhen City (CN)

(21) Appl. No.: 13/171,455

(22) Filed: Jun. 29, 2011

(30) Foreign Application Priority Data
Sep. 13, 2010 (CN) 201010279653.X

(51) Int. Cl. G06M 1/22; G06M 1/00

(52) U.S. Cl. 377/6

(57) ABSTRACT

A screw counter includes a first interface, a second interface, and a processing unit. The first interface connected to a screwdriver, the screwdriver is adapted for screwing a predetermined total number of screws into a workpiece to perform a screwing operation on the workpiece. The second interface is connected to a detecting unit. The detecting unit detects a start time and a finish time of the screwing operation. The processing unit counts a variable, each time when the processing unit is changed from a first state to a second state, the variable adds one; a total added value of the variable is calculated during a time interval between the start time and the finish time to acquire a total number of screws which are completely screwed into the workpiece.

### BACKGROUND

1. Technical Field

The disclosed embodiments relate to screw counters, and more particularly to a screw counter and an electronic device using the same.

2. Description of Related Art

A screwdriver is widely used for screwing a plurality of screws into a workpiece, for example a casing of electronic devices, such as computers, televisions, etc., during assemble of the electronic devices. However, it is difficult and not precise for an operator to manually determine whether the screw is completely screwed into a workpiece and to know a total number of screws which are completely screwed into the workpiece.

What is needed, therefore, is a screw counter and an electronic device to overcome the above described limitations.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout two views.

FIG. 1 is a block diagram showing an electronic device in accordance with one embodiment, the electronic device includes a screw counter.

FIG. 2 is a schematic view showing that a workpiece is placed on a workbench.

### DETAILED DESCRIPTION

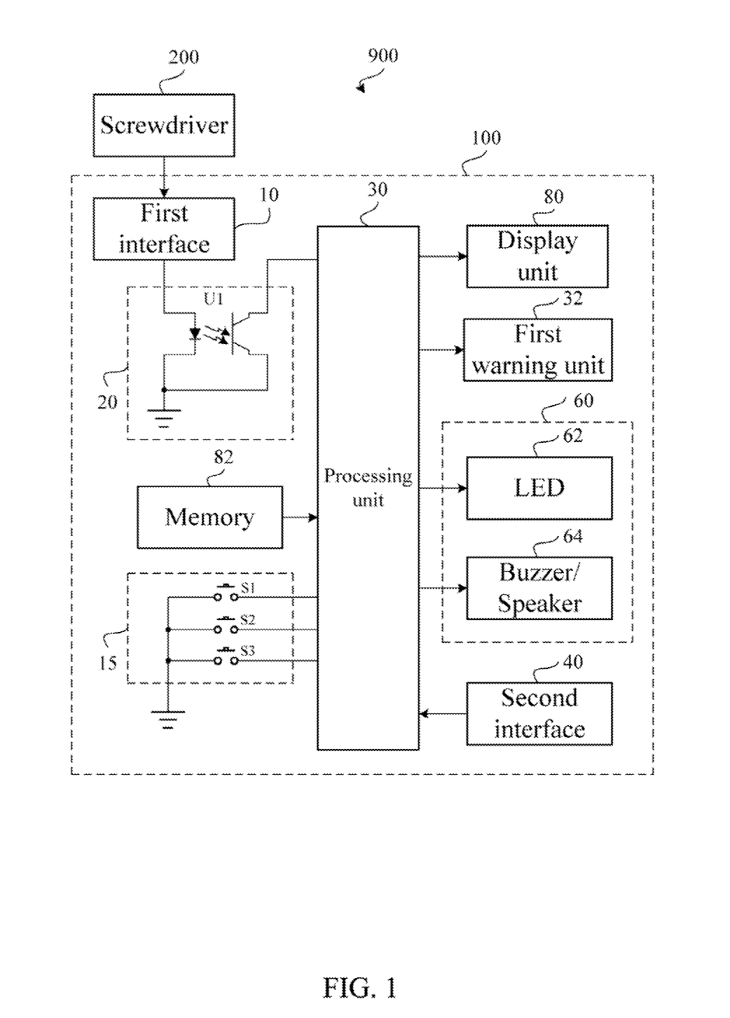

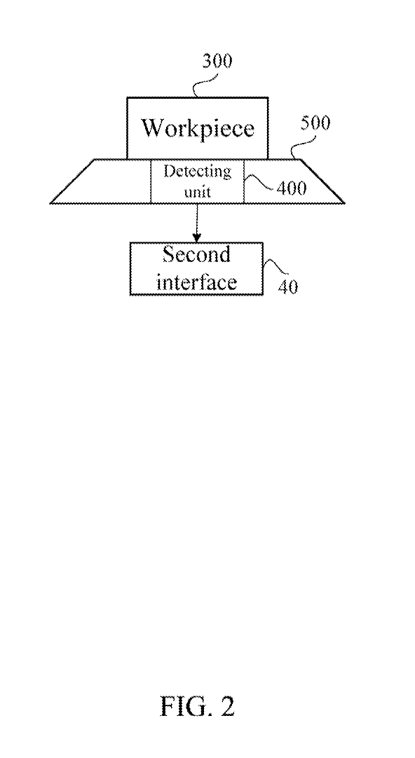

Referring to FIGS. 1 and 2, an electronic device 900 includes a screw counter 100 and a detecting unit 400. The screw counter 100 includes a first interface 10, an input unit 15, a converting unit 20, a processing unit 30, a first warning unit 32, a second interface 40, a second warning unit 60, a display unit 80, and a memory 82.

A screwdriver 200 is connected to the first interface 10. The screwdriver 200 is adapted for screwing a predetermined total number of screws into a workpiece 300 to perform a screwing operation on the workpiece 300, when all of the screws are completely screwed into the workpiece 300, the screwing operation is completed. In this embodiment, the predetermined total number of screws can be one screw, two screws, or more than two screws.

The input unit 15 is used for receiving the predetermined total number input by users. In detail, the input unit 15 includes a first button S1, a second button S2, and a third button S3. The first button S1 is used for adding one to the predetermined total number when pressed, the second button S2 is used for subtracting one from the predetermined total number when pressed, the third button S3 is used to reset the predetermined total number when pressed.

The screwdriver 200 further generates a feedback signal when a screw is being screwed into the workpiece 300, and stops generating the feedback signal when the screw is completely screwed into the workpiece 300. In this embodiment, the screwdriver 200 is powered by a supply voltage from a power source (not shown), and the feedback signal is the supply voltage.

The first interface 10 is used for transmitting the feedback signal to the converting unit 20.

The converting unit 20 is used for converting the feedback signal to a signal suited for the processing unit 30. The converting unit 20 includes an optical coupler U1, the optical coupler U1 includes a first input terminal connected to the first interface 10, a second input terminal, a first output terminal connected to the processing unit 30, and a second output terminal. The second input terminal and the second output terminal are grounded.

The processing unit 30 is in a first state at which the processing unit 30 receives the converted feedback signal from the converting unit 20 when the screw is being screwed into the workpiece 300, and in a second state at which the processing unit 30 stops receiving the converted feedback signal when the screw is completely screwed into the workpiece 300. The first warning unit 32 outputs a first warning signal when the processing unit 30 is changed from the first state to the second state. Therefore, users know whether the screw is completely screwed into the workpiece 300. In other embodiments, the screw counter 100 does not include the converting unit 20, therefore the processing unit 30 directly receives the feedback signal from the screwdriver 200 through the first interface 10.

The detecting unit 400 is used for detecting a start time and a finish time of the screwing operation. In detail, the detecting unit 400 is mounted to a workbench 500 for detecting whether the workpiece 300 is placed on or removed from the workbench 500. When the workpiece 300 is placed on the workbench 500, the start time of the screw operation is determined. When the workpiece 300 is removed from the workbench 500, the finish time of the screw operation is determined.

The second interface 40 is connected to the detecting unit 400, and is used for transmitting the start time and the finish time to the processing unit 30.

The processing unit 30 is further used for counting a variable. An initial value of the variable is zero, each time when the processing unit 30 is changed from the first state at which the processing unit 30 receives the converted feedback signal from the converting unit 20 to the second state at which the processing unit 30 stops receiving the converted feedback signal, the variable adds one. A total added value of the variable is calculated during a time interval between the start time and the finish time to acquire a total number of screws which are completely screwed into the workpiece 300. The acquired total number of screws equals to the total added value of the variable. The screw counter 100 further includes a reset button (not shown), when the reset button is pressed, the value of the variable returns to zero.

The processing unit 30 further generates a control signal when the acquired total number of screws is not equivalent to the predetermined total number of screws, the second warning unit 60 outputs a second warning signal according to the control signal.

In this embodiment, the second warning unit 60 includes light emitting diode (LED) 62, the LED 62 emits light or flickers when the acquired total number of screws is not equivalent to the predetermined total number of screws. In other embodiments, the second warning unit 60 includes a speaker or a buzzer 64, the speaker or the buzzer 64 outputs an audible warning signal, for example voice warning signal, when the acquired total number of screws is not equivalent to the predetermined total number of screws. Therefore, users are informed that the acquired total number of screws is not equivalent to the predetermined total number of screws, the error is effectively prevented.

The display unit 80 includes a first display unit and a second display unit, the first display unit is used for displaying the predetermined total number of screws, and the second display unit is used for displaying the acquired total number of screws.

The memory 82 stores the predetermined total number of screws and the acquired total number of screws, therefore when the screw counter 100 is accidently powered off, the data loss is effectively prevented.

Alternative embodiments will become apparent to those skilled in the art without departing from the spirit and scope of what is claimed. Accordingly, the present invention should be deemed not to be limited to the above detailed description, but rather only by the claims that follow and equivalents thereof.

What is claimed is:

1. A screw counter, comprising:
a first interface connected to a screwdriver, the screwdriver adapted for screwing a predetermined total number of screws into a workpiece to perform a screwing operation on the workpiece;
a second interface connected to a detecting unit; and
a processing unit;
wherein the processing unit is in a first state at which the processing unit receives a feedback signal from the screwdriver through the first interface when a screw is being screwed into the workpiece, and in a second state at which the processing unit stops receiving the feedback signal when the screw is completely screwed into the workpiece; when all of the screws are completely screwed into the workpiece, the screwing operation is completed; the detecting unit detects a start time and a finish time of the screwing operation; the processing unit further counts a variable and further receives the start time and the finish time from the second interface, each time when the processing unit is changed from the first state to the second state, the variable adds one; a total added value of the variable is calculated during a time interval between the start time and the finish time to acquire a total number of screws which are completely screwed into the workpiece.

2. The screw counter of claim 1, wherein an initial value of the variable is zero, the acquired total number of screws equals to the total added value of the variable.

3. The screw counter of claim 1, further comprising a first warning unit, wherein the processing unit further generates a control signal when the acquired total number of screws is not equivalent to the predetermined total number of screws, the first warning unit outputs a first warning signal according to the control signal.

4. The screw counter of claim 1, wherein the detecting unit is mounted to a workbench, when the workpiece is placed on the workbench, the start time is determined; when the workpiece is removed from the workbench, the finish time is determined.

5. The screw counter of claim 1, wherein the screwdriver is powered by a supply voltage, the feedback signal is the supply voltage.

6. The screw counter of claim 5, wherein the screwdriver comprises a converting unit, the converting unit is connected between the first interface and the processing unit and is used for converting the feedback signal to a signal suited for the processing unit.

7. The screw counter of claim 6, wherein the converting unit comprises an optical coupler, the optical coupler includes a first input terminal connected to the first interface, a second input terminal being grounded, a first output terminal connected to the processing unit, and a second output terminal being grounded.

8. The screw counter of claim 1, further comprising a first display unit for displaying the predetermined total number of screws and a second display unit for displaying the acquired total number of screws.

9. The screw counter of claim 3, wherein the first warning unit comprises a light emitting diode (LED), the LED emits light or flickers when the acquired total number of screws is not equivalent to the predetermined total number of screws.

10. The screw counter of claim 3, wherein the first warning unit comprises a speaker or a buzzer, the speaker or the buzzer outputs an audible warning signal when the acquired total number of screws is not equivalent to the predetermined total number of screws.

11. The screw counter of claim 3, further comprising a memory for storing the predetermined total number of screws and the acquired total number of screws.

12. The screw counter of claim 1, further comprising an input unit for receiving the predetermined total number input by users, wherein the input unit comprises a first button, a second button, and a third button, the first button is used for adding one to the predetermined total number when pressed, the second button is used for subtracting one from the predetermined total number when pressed, the third button is used to reset the predetermined total number when pressed.

13. The screw counter of claim 1, further comprising a second warning unit for outputting a second warning signal when the processing unit is changed from the first state to the second state.

14. An electronic device, comprising:
a detecting unit; and
a screw counter, the screw counter comprising:
a first interface connected to a screwdriver, the screwdriver adapted for screwing a predetermined total number of screws into a workpiece to perform a screwing operation on the workpiece;
a second interface connected to a detecting unit; and
a processing unit;
wherein the processing unit is in a first state at which the processing unit receives a feedback signal from the screwdriver through the first interface when a screw is being screwed into the workpiece, and in a second state at which the processing unit stops receiving the feedback signal when the screw is completely screwed into the workpiece; when all of the screws are completely screwed into the workpiece, the screwing operation is completed; the detecting unit detects a start time and a finish time of the screwing operation; the processing unit further counts a variable and further receives the start time and the finish time from the second interface, each time when the processing unit is changed from the first state to the second state, the variable adds one; a total added value of the variable is calculated during a time interval between the start time and the finish time to acquire a total number of screws which are completely screwed into the workpiece.

15. The electronic device of claim 14, wherein an initial value of the variable is zero, the acquired total number of screws equals to the total added value of the variable.

16. The electronic device of claim 14, wherein the screw counter further comprises a first warning unit, wherein the processing unit generates a control signal when the acquired total number of screws is not equivalent to the predetermined total number of screws, the first warning unit outputs a first warning signal according to the control signal.

17. The electronic device of claim 14, wherein the detecting unit is mounted to a workbench, when the workpiece is placed on the workbench, the start time is determined; when the workpiece is removed from the workbench, the finish time is determined

18. The electronic device of claim 14, wherein the screw counter further comprises a second warning unit for outputting a second warning signal when the processing unit is changed from the first state to the second state.

19. A screw counter, comprising:
a first interface connected to a screwdriver, the screwdriver adapted for screwing a predetermined total number of screws into a workpiece to perform a screwing operation on the workpiece;
a second interface connected to a detecting unit; and
a processing unit being in a first state at which the processing unit receives a feedback signal from the screwdriver through the first interface when a screw is being screwed into the workpiece, and in a second state at which the processing unit stops receiving the feedback signal when the screw is completely screwed into the workpiece; and
a warning unit for outputting a warning signal when the processing unit is changed from the first state to the second state.
